(19) United States
(12) Patent Application Publication
(10) Pub. No.: US 2025/0363649 A1
(43) Pub. Date: Nov. 27, 2025

(54) DEPTH ESTIMATION METHOD, ELECTRONIC DEVICE, AND STORAGE MEDIUM

(71) Applicant: HON HAI PRECISION INDUSTRY CO., LTD., New Taipei (TW)

(72) Inventors: TSUNG-WEI LIU, New Taipei (TW); Chin-Pin KUO, New Taipei (TW)

(21) Appl. No.: 19/027,289

(22) Filed: Jan. 17, 2025

(30) Foreign Application Priority Data
May 22, 2024 (CN) 202410640518.5

(51) Int. Cl. G06T 7/50; G06T 7/11; G06T 7/73

(52) U.S. Cl. CPC G06T 7/50; G06T 7/11; G06T 7/73; G06T 2207/20021; G06T 2207/20084

(57) ABSTRACT

The present application provides a depth estimation method, an electronic device and a storage medium, the method includes dividing an initial image into a plurality of sub-region images, and obtaining a feature vector corresponding to each sub-region image of the plurality of sub-region images by performing a feature extraction on each sub-region image. Once the feature vector corresponding to each sub-region image is input into a depth estimation model, and depth information corresponding to each feature vector is obtained using encoders of the depth estimation model, a depth image corresponding to the initial image is obtained using decoders of the depth estimation model based on the depth information corresponding to each feature vector. The present application can assist in a depth estimation and improve an accuracy of estimating a depth of an image.

### TECHNICAL FIELD

The present application relates to a technical field of depth estimation, and in particular to a depth estimation method, an electronic device, and a storage medium.

### BACKGROUND

A model structure used in a traditional depth estimation model is relatively simple and may be limited by a receptive field. In a convolutional neural network, the receptive field can be a size of an area mapped by pixels on a feature map output by each layer of the convolutional neural network on an input image. Due to the limitation of the receptive field, a depth estimation result of an image is poor and an accurate depth inference cannot be obtained.

### BRIEF DESCRIPTION OF THE DRAWINGS

In order to more clearly illustrate embodiments of the present application or technical solutions in a prior art, drawings required for use in the embodiments or a description of the prior art will be briefly introduced below. Obviously, the drawings described below are merely embodiments of the present application. For an ordinary skilled in the art, other drawings can be obtained based on the provided drawings without paying any creative work.

FIG. 1 is an architecture diagram of an electronic device provided in an embodiment of the present application.

FIG. 2 is a flow chart of a depth estimation method provided in an embodiment of the present application.

FIG. 3 is a detailed flow chart of a block S21 in the flow chart shown in FIG. 2 provided in an embodiment of the present application.

FIG. 4 is a schematic diagram of a structure of a linear self-attention mechanism provided in an embodiment of the present application.

FIG. 5 is a structural diagram of a depth estimation device provided in an embodiment of the present application.

Following embodiments are further illustrate the present application in conjunction with the above-mentioned drawings.

### DETAILED DESCRIPTION

In order to more clearly understand the above-mentioned purposes, features and advantages of the present application, the present application is described in detail below in conjunction with the accompanying drawings and specific embodiments. It should be noted that the embodiments of the present application and the features in the embodiments can be combined with each other without conflict.

In the following description, many specific details are set forth to facilitate a full understanding of the present application. The described embodiments are only a part of the embodiments of the present application, rather than all of the embodiments. Based on the embodiments in the present application, all other embodiments obtained by ordinary technicians in this field without creative work are within a scope of protection of the present application.

Unless otherwise defined, all technical and scientific terms used herein have the same meaning as those commonly understood by those skilled in the art to which this application belongs. The terms used herein in the specification of this application are only for a purpose of describing specific embodiments and are not intended to limit this application.

In one embodiment, the model structure used in the commonly used depth estimation model is relatively simple, and is easily limited by the receptive field, resulting in poor depth estimation results and failure to obtain accurate depth inference.

In order to solve the problem, a depth estimation model provided in the embodiment of the present application divides an image into a plurality of sub-regions, and considers a correlation between each of the plurality of sub-regions at different positions when using a pre-trained depth estimation model, thereby expanding the receptive field of a depth estimation algorithm and improving an accuracy of depth estimation.

For example, as shown in FIG. 1, it is a structural diagram of an electronic device provided in an embodiment of the present application. The depth estimation method provided in an embodiment of the present application is performed by an electronic device, and the electronic device can be a computer, a server, a laptop computer, a mobile phone, etc. The electronic device 1 includes a storage device 11, at least one processor 12, at least one communication bus 13, and a transceiver 14.

The structure of the electronic device shown in FIG. 1 does not constitute a limitation of the embodiments of the present application, and may be either a bus structure or a star structure. The electronic device 1 may also include more or less other hardware or software than shown in the figure, or a different arrangement of components.

In some embodiments, the electronic device 1 is a device that can automatically perform numerical calculations and/or information processing according to pre-set or stored instructions, and its hardware includes but is not limited to microprocessors, application-specific integrated circuits, programmable gate arrays, digital processors, and embedded devices. The electronic device 1 may also include other external devices, such as input and output devices such as a keyboard, a mice, a remote control, a display, a touch panel, or a voice control device.

It should be noted that the electronic device 1 is only an example, and other existing or future electronic products that are suitable for the present application should also be included in a protection scope of the present application and included here by reference.

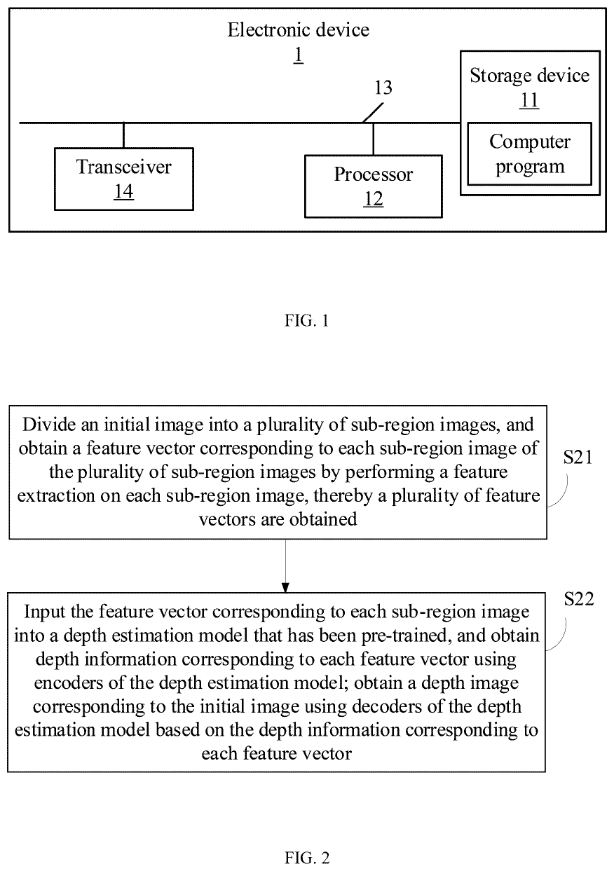

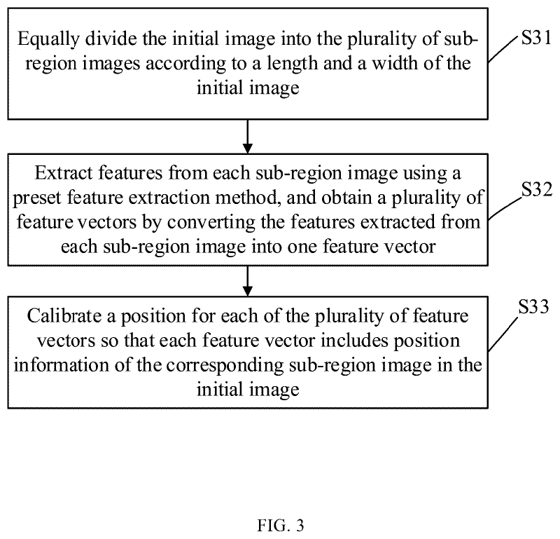

FIG. 2 illustrates a depth estimation method provided in an embodiment of the present application. The depth estimation method is applied to an electronic device, such as the electronic device 1 shown in FIG. 1, and specifically includes the following blocks. According to different requirements, an order of the blocks in the flow chart can be changed, and some blocks may be omitted.

Block S21, the electronic device divides an initial image into a plurality of sub-region images, and obtains a feature vector corresponding to each sub-region image of the plurality of sub-region images by performing a feature extraction on each sub-region image, thereby a plurality of feature vectors are obtained.

In one embodiment, the initial image is an original image that requires a depth estimation. The electronic device may receive the initial image input by a user, and may also pre-store the initial image in a preset storage location of the electronic device. In addition, the electronic device may also obtain the initial image through a capture device, and the initial image may be a depth image.

Since a size of the initial image may be large and may include many features (such as people and vehicles), a feature extraction performed on the entire initial image may result in inaccurate feature extraction and omissions.

To solve the above problem, in one embodiment, the initial image can be divided into the plurality of sub-region images, and the feature extraction is performed on each sub-region image, so as to obtain the feature vector corresponding to each sub-region image. By dividing the entire image into the plurality of sub-region images and extracting features by region, an accuracy and a precision of the feature extraction can be effectively improved. In addition, the feature extraction can be performed on the plurality of sub-region images of smaller sizes at the same time, which can also improve an efficiency of feature extraction.

In one embodiment, as shown in FIG. 3, a detailed flow chart of block S21 provided in an embodiment of the present application specifically includes the following blocks:

Block S31, the electronic device equally divides the initial image into the plurality of sub-region images according to a length and a width of the initial image.

In one embodiment, the initial image with a length of H and a width of W is equally divided into H′×W′ sub-region images, where the length H may be a total number of pixels on a long side of the initial image, and the width W may be a total number of pixels on a wide side of the initial image. In addition, both H′ and W′ represent positive integers and can be set according to actual needs, for example, H′=4 and W′=3. In other embodiments, H′:W′=H:W can also be set.

Block S32, the electronic device extracts features from each sub-region image using a preset feature extraction method, and obtains a plurality of feature vectors by converting the features extracted from each sub-region image into one feature vector.

In one embodiment, the preset feature extraction method includes but is not limited to a scale-invariant feature transformation algorithm and a directional gradient histogram algorithm. In one embodiment, a neural network (such as a convolutional neural network) for the feature extraction may also be pre-trained to obtain a feature extraction model, and the feature extraction model may be used to extract features from the sub-region image.

After extracting the features from each sub-region image, the features can be reduced in dimension. For example, a principal component analysis (PCA) method may be used to reduce the dimension of the extracted features to obtain the feature vector corresponding to the features.

Specifically, the principal component analysis method maps M (e.g., 2) dimensional features to N (e.g., 1) dimensional features. The N dimensional features obtained by mapping are new orthogonal features of principal components, which are N dimensional features reconstructed on a basis of the M dimensional features. The principal component analysis method has two blocks: demeaning samples to 0, that is, subtracting a mean of the samples from all samples; determining a unit vector with a largest variance after mapping the samples, and performing a mapping in a direction of the unit vector. The principal component analysis method can transform closely related variables into as few new variables as possible, so that these new variables are unrelated to each other, and can use fewer comprehensive indicators to represent various types of information in each variable, thereby achieving an effect of reducing data dimensionality.

Block S33, the electronic device calibrates a position for each of the plurality of feature vectors so that each feature vector includes position information of the corresponding sub-region image in the initial image.

In one embodiment, each feature vector corresponds to one sub-region image, and different sub-region images have different positions in the initial image. In order to establish a corresponding relationship between each feature vector and the initial image, it is necessary to perform a position embedding on each feature vector so that each feature vector includes the position information of the corresponding sub-region image in the initial image. By performing the position embedding on each feature vector, the depth image corresponding to the initial image can be restored based on the position embedding after a subsequent depth estimation based on the feature vector.

Block S22, the electronic device inputs the feature vector corresponding to each sub-region image into a depth estimation model that has been pre-trained, and obtains depth information corresponding to each feature vector using encoders of the depth estimation model; obtains a depth image corresponding to the initial image using decoders of the depth estimation model based on the depth information corresponding to each feature vector.

In one embodiment, the depth estimation model includes a Transformer model, the Transformer model includes a plurality of encoders and a plurality of decoders, and each encoder of the Transformer model includes a linear self-attention mechanism and a multilayer perceptron (MLP).

In addition, a number of the plurality of encoders is equal to a number (for example, 6) of the plurality of decoders, an input of a t-th encoder is an output of a (t−1)-th encoder; and an input of the tth decoder includes an output of each encoder in addition to an output of a (t−1)-th decoder, and “t” represents an integer greater than 1.

In one embodiment, when inputting the feature vectors into the depth estimation model that has been pre-trained, all feature vectors can be combined into a combination matrix, and the combination matrix is input into the depth estimation model, where each row vector in the combination matrix corresponds to one feature vector. Since the combination matrix includes all feature information of the initial image, the depth estimation of the combination matrix can be performed using the linear self-attention mechanism and the multilayer perceptron of the depth estimation model, and a better result of the depth estimation can be obtained. In other embodiments, all feature vectors can also be combined into a combination vector.

In one embodiment, after the feature vectors have been input into the depth estimation model, the t-th encoder outputs Xₜ using the following formula:

$${X}_{c} = Transformer ( {X}_{t - 1} ) = M A ( {X}_{t - 1} ) + M L P ( M A ( {X}_{t - 1} ) ) ,$$

Where, “t” represents an integer greater than 1, “Xₜ₋₁” represents an output of the (t−1)-th encoder, “MA” represents the linear self-attention mechanism, and “MLP” represents the multilayer perceptron.

In one embodiment, the linear self-attention mechanism is a multi-head attention mechanism, which can establish associations between multiple feature vectors that have been input, thereby establishing an association between features at any two positions in the initial image, and can expand the receptive field of the neural network such as the encoder to a global range to obtain the better result of the depth estimation.

In addition, compared with the traditional multi-head attention mechanism, the linear self-attention mechanism can use a projection matrix to effectively reduce a complexity of self-attention in time and space, thereby reducing a memory occupancy of an operation of the model and improving an operation efficiency of the model.

In one embodiment, the linear self-attention mechanism associates inputs using the following formula:

$$M A ( X ) = conact ( {A}_{1} ( X ) , {A}_{2} ( X ) , … , {A}_{m} ( X ) , … , {A}_{n} ( X ) ) {W}_{M A} ,$$

Among them,

$${A}_{m} ( X ) = X + softmax ( \frac{X {W}_{m Q} {E}_{m} X {W}_{m K}}{\sqrt{{d}_{l}}} ) {F}_{m} X {W}_{m V} ,$$

“Aₘ” represents a m-th attention head in n-head self-attention, “X” represents an input of the linear self-attention mechanism, “softmax” represents a softmaxfunction, “conact” represents a conactfunction, “W_{MA}”, “W_{mQ}”, “W_{mK}”, “W_{mV}”, “Eₘ” and “Fₘ” represent matrices that have been pre-trained, “dₗ” represents a number of columns of a vector “K”, where K=XW_{mK}. Among them, “n” and “m” both represent positive integers, and a value range of “m” is 1 to “n”.

In one embodiment, the linear self-attention mechanism multiplies the input “X” (such as the combination matrix) with the pre-trained weight matrix “W_{mQ}” to obtain a matrix “Q” (query), multiplies the input “X” with the pre-trained weight matrix “W_{mV}” to obtain a matrix “V” (value), and multiplies the input “X” with the pre-trained weight matrix “W_{mK}” to obtain a matrix “K” (key), thereby obtaining three matrices, and more parameters can be used to perform model operations to improve the model's operational effect. Among them, the matrix dimension of the matrix “Q” and the matrix dimension of the matrix “K” are equal.

In one embodiment, since each feature vector has a different position in the initial image and corresponds to different features, it is necessary to calculate an attention score of each feature vector so that the model pays more attention to feature vectors with higher attention scores. When the input “X” represents the combination matrix, an attention score vector can be directly calculated using the combination matrix, where each element in the attention score vector represents the attention score of one feature vector.

In one embodiment, a method for calculating the attention score includes but is not limited to a scaled dot-product attention algorithm, which can use dot products to obtain a more computationally efficient scoring function:

$$\frac{Q {E}_{m} K}{\sqrt{{d}_{l}}} = \frac{X {W}_{m Q} {E}_{m} X {W}_{m K}}{\sqrt{{d}_{l}}} ,$$

where “Eₘ” represents a pre-trained projection matrix of the linear self-attention mechanism.

In one embodiment, after the attention scores are calculated, the attention scores are normalized using the softmax function:

$$softmax ( \frac{X {W}_{m Q} {E}_{m} X {W}_{m K}}{\sqrt{{d}_{l}}} ) ,$$

so that all attention scores are positive and a sum of all attention scores is 1.

In one embodiment, in order to ensure that eigenvalues of the feature vectors to be focused on remain unchanged and to remove tiny eigenvalues therein, the standardized attention score is multiplied by FₘXW_{mV}. Where, “Fₘ” represents the pre-trained projection matrix of the linear self-attention mechanism, “Fₘ” and “Eₘ” have the same matrix dimension.

In one embodiment, since the linear self-attention mechanism is the multi-head attention mechanism, it is necessary to establish a connection between each attention head to expand the receptive field of the model:

$$contact ( {A}_{1} ( X ) , {A}_{2} ( X ) , … , {A}_{m} ( X ) , … , {A}_{n} ( X ) ) {W}_{M A} .$$

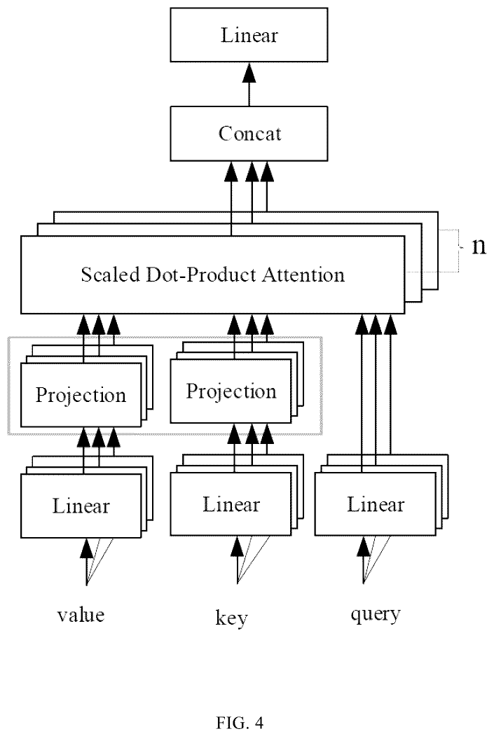

In one embodiment, as shown in FIG. 4, it is a schematic diagram of a structure of the linear self-attention mechanism provided in the embodiment of the present application. Compared with the general self-attention mechanism, the linear self-attention mechanism in the embodiment of the present application includes two projection modules using projection matrices.

In one embodiment, the multilayer perceptron is an artificial neural network having a forward structure, and includes an input layer, an output layer, and a preset number of hidden layers (the preset number can be an integer greater than or equal to 1, such as 4), and each layer of neurons is a fully connected structure. An input of a latter layer of the multilayer perceptron is an output of a previous layer, and an output of each layer is nonlinearly transformed using an activation function (such as a Relu function), which can solve nonlinear problems that a single-layer perceptron cannot handle.

In one embodiment, the multilayer perceptron uses the following formula to obtain the output:

$$M L P ( X ) = X {\prod }_{r = 1}^{R} {W}_{r} ,$$

Among them, “X” represents an input of the multilayer perceptron, “r” represents the r-th hidden layer of the multilayer perceptron, “R” represents a number of hidden layers of the multilayer perceptron, and “Wᵣ” represents a weight matrix of the r-th hidden layer.

In one embodiment, after the depth information corresponding to each feature vector of the initial image is obtained using the encoders, a corresponding depth image is obtained using the decoders based on the depth information corresponding to each feature vector, the depth image is generated based on the depth information corresponding to each feature vector and the corresponding position that is calibrated. In this way, the depth information corresponding to each feature vector can be corresponded to the position of the corresponding sub-region image in the initial image, and the depth image corresponding to the entire initial image can be restored.

In one embodiment, the depth estimation method includes: obtaining a training set and a test set, and initializing model parameters (such as the weight matrix, the projection matrix, etc.); training an initial model using the training set, testing the initial model using the test set and updating the model parameters (such as updating the weight matrix) until a model with a converged loss function (such as the L1 norm) is obtained as the depth estimation model.

In one embodiment, the depth estimation method provided by the present application improves the accuracy and efficiency of depth estimation by dividing the image into the plurality of sub-regions and using the linear self-attention mechanism and the multilayer perceptron to expand the receptive field of the depth estimation algorithm when using the pre-trained depth estimation model.

The depth estimation method provided in this application can be applied to a monocular depth estimation. By estimating a depth of an image, a distance to an object in the image can be detected, thereby improving a detection accuracy of a distance of an object. For example, in the field of intelligent driving, by detecting the distance to objects on a road during driving, a driving safety of a user can be improved. In one embodiment, the electronic device can control a camera device of a vehicle to capture an image of a scene in front of the vehicle, and obtain a depth image corresponding to the image of the scene in front of the vehicle using the above depth estimation method provided in the embodiment of the present application, and then determine a distance between the vehicle and an object in the scene in front of the vehicle based on the depth image; and further control the vehicle according to the distance. For example, when the distance is less than a preset value, the electronic device can control the vehicle to slow down.

Furthermore, in other embodiments of the present application, after determining the distance between the object and the vehicle, the distance may be compared with a preset distance threshold. If the distance is less than or equal to the preset distance threshold, a prompt message is output. For example, if the present application is applied in a field of intelligent driving, when the distance is less than or equal to the preset distance threshold, not only can a prompt message be output by voice or other means, but also a deceleration control may be performed on the vehicle that is moving, for example, gradually decelerating within a preset period of time until it stops within the distance.

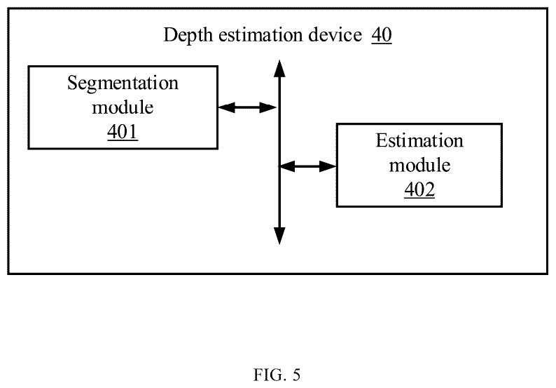

FIG. 5 is a structural diagram of a depth estimation device provided in an embodiment of the present application.

In some embodiments, a depth estimation device 40 may include multiple functional modules composed of computer program segments. The computer programs of various program segments in the depth estimation device 40 may be stored in a storage device of an electronic device and executed by at least one processor to perform the function of depth estimation (see FIG. 2 for details).

In this embodiment, the depth estimation device 40 can be divided into multiple functional modules according to functions performed. The functional modules may include: a segmentation module 401, an estimation module 402. The module referred to in this application refers to a series of computer program segments that can be executed by at least one processor and can complete fixed functions, which are stored in a storage device. In this embodiment, the functional implementation of each module in the depth estimation device 40 can refer to the above definition of the depth estimation method, and will not be repeated here.

The segmentation module 401 is used to segment an initial image into a plurality of sub-region images, and obtain a feature vector corresponding to each sub-region image of the plurality of sub-region images by performing a feature extraction on each sub-region image, thereby a plurality of feature vectors are obtained.

The estimation module 402 is used to input the feature vector corresponding to each sub-region image into a depth estimation model that has been pre-trained, and obtain depth information corresponding to each feature vector uses encoders of the depth estimation model; obtain a depth image corresponding to the initial image using decoders of the depth estimation model based on the depth information corresponding to each feature vector.

Continuing with the above description of FIG. 1, a computer program is stored in the storage device 11, and when the computer program is executed by the at least one processor 12, all or part of the blocks in the depth estimation method are implemented. The storage device 11 includes a read-only memory (ROM), a programmable read-only memory (PROM), an erasable programmable read-only memory (EPROM), a one-time programmable read-only memory (OTPROM), an electronically erasable rewritable read-only memory (EEPROM), a compact disc read-only memory (CD-ROM) or other optical disc storage, magnetic disk storage, magnetic tape storage, or any other computer-readable medium that can be used to carry or store data.

Furthermore, the computer-readable storage medium may mainly include a program storage area and a data storage area, where the program storage area may store an operating system, an application required for at least one function, etc.; the data storage area may store data created according to the use of the blockchain node, etc.

In one embodiment of the present application, a computer program is stored on the computer-readable storage medium, and when the computer program is executed by the processor 12, the process shown in FIG. 2 is implemented.

In some embodiments, the at least one processor 12 is a control unit of the electronic device 1, and uses various interfaces and lines to connect various components of the entire electronic device 1, and executes various functions and processes data of the electronic device 1 by running or executing programs or modules stored in the storage device 11, and invoking data stored in the storage device 11. For example, when the at least one processor 12 executes the computer program stored in the storage device, it implements all or part of the blocks of the depth estimation method described in the embodiment of the present application; or implements all or part of the functions of the depth estimation device. The at least one processor 12 can be composed of an integrated circuit, for example, it can be composed of a single packaged integrated circuit, or it can be composed of multiple integrated circuits with the same function or different functions, including one or more central processing units (CPUs), microprocessors, digital processing chips, graphics processors, and a combination of various control chips.

In some embodiments, the at least one communication bus 13 is configured to implement connection communication between the storage device 11 and the at least one processor 12, etc.

Although not shown, the electronic device 1 may also include a power source (such as a battery) for supplying power to each component. Preferably, the power source may be logically connected to the at least one processor 12 through a power management device, so that the power management device can manage charging, discharging, and power consumption. The power source may also include one or more DC or AC power sources, recharging devices, power failure detection circuits, power converters or inverters, power status indicators, and other arbitrary components. The electronic device 1 may also include a variety of sensors, Bluetooth modules, Wi-Fi modules, camera devices, etc., which will not be repeated here.

The above-mentioned integrated unit implemented in the form of a software function module can be stored in a computer-readable storage medium. The above-mentioned software function module is stored in a storage medium, including a number of instructions for enabling a computer device (which can be a personal computer, electronic device, or network device, etc.) or a processor to execute part of the method described in each embodiment of the present application.

In the several embodiments provided in this application, it should be understood that the disclosed devices and methods can be implemented in other ways. For example, the device embodiments described above are only schematic, for example, the division of the modules is only a logical function division, and there may be other division methods in actual implementation.

The modules described as separate components may or may not be physically separated, and the components shown as modules may or may not be physical units, and may be located in one place or distributed on multiple network units. Some or all of the modules may be selected according to actual needs to achieve the purpose of the solution of this embodiment.

In addition, each functional module in each embodiment of the present application can be integrated into one processing unit, or each unit can exist physically separately, or two or more units can be integrated into one unit. The above-mentioned integrated unit can be implemented in the form of hardware or in the form of hardware plus software functional modules.

It is obvious to those skilled in the art that the present application is not limited to the details of the above exemplary embodiments, and that the present application can be implemented in other specific forms without departing from the spirit or basic features of the present application. Therefore, from any point of view, the embodiments should be regarded as exemplary and non-restrictive, and the scope of the present application is limited by the attached claims rather than the above description, so it is intended to include all changes that fall within the meaning and scope of the equivalent elements of the claims in the present application. Any figure mark in the claims should not be regarded as limiting the claims involved. In addition, it is obvious that the word “including” does not exclude other units or, and the singular does not exclude the plural. Multiple units or devices stated in the specification can also be implemented by one unit or device through software or hardware. The words first, second, etc. are used to indicate names, and do not indicate any particular order.

Finally, it should be noted that the above embodiments are only used to illustrate the technical solution of the present application and are not intended to limit it. Although the present application has been described in detail with reference to the preferred embodiments, a person of ordinary skill in the art should understand that the technical solution of the present application may be modified or replaced by equivalents without departing from the spirit and scope of the technical solution of the present application.

What is claimed is:

1. A depth estimation method, comprising:
dividing an initial image into a plurality of sub-region images, and obtaining a feature vector corresponding to each sub-region image of the plurality of sub-region images by performing a feature extraction on each sub-region image;
inputting the feature vector corresponding to each sub-region image into a depth estimation model, and obtaining depth information corresponding to each feature vector using encoders of the depth estimation model; and
obtaining a depth image corresponding to the initial image using decoders of the depth estimation model based on the depth information corresponding to each feature vector.

2. The depth estimation method according to claim 1, wherein the depth estimation model comprises a Transformer model, the Transformer model comprises the encoders and the decoders, and each of the encoders comprises a linear self-attention mechanism and a multilayer perceptron.

3. The depth estimation method according to claim 2, wherein a t-th encoder of the decoders outputs Xₜ using a formula:
$${X}_{t} = Transformer ( {X}_{t - 1} ) = M A ( {X}_{t - 1} ) + M L P ( M A ( {X}_{t - 1} ) ) ,$$
wherein, “t” represents an integer greater than 1, “Xₜ₋₁” represents an output of the (t−1)-th encoder, “MA” represents the linear self-attention mechanism, and “MLP” represents the multilayer perceptron.

4. The depth estimation method according to claim 3, wherein the linear self-attention mechanism associates inputs using a formula:
$$MA ( X ) = contact ( {A}_{1} ( X ) , {A}_{2} ( X ) , … , {A}_{m} ( X ) , … , {A}_{n} ( X ) ) {W}_{M A} ,$$
wherein,
$${A}_{m} ( X ) = X + softmax ( \frac{X {W}_{m Q} {E}_{m} X {W}_{m K}}{\sqrt{{d}_{l}}} ) {F}_{m} X {W}_{m V} ,$$
“Aₘ” represents a m-th attention head in n-head self-attention, “X” represents an input of the linear self-attention mechanism, “softmax” represents a softmax function, “conact” represents a conact function, “W_{MA}”, “W_{mQ}”, “W_{mK}”, “W_{mV}”, “Eₘ” and “Fₘ” represent matrices that have been pre-trained, “dₗ” represents a number of columns of a vector “K”, where K=XW_{mK}.

5. The depth estimation method according to claim 4, wherein the multilayer perceptron obtains an output using a formula:
$$M L P ( X ) = X {\prod }_{r = 1}^{R} {W}_{r} ,$$
wherein “X” represents an input of the multilayer perceptron, “r” represents a r-th hidden layer of the multilayer perceptron, “R” represents a number of hidden layers of the multilayer perceptron, and “Wᵣ” represents a weight matrix of the r-th hidden layer.

6. The depth estimation method according to claim 1, wherein the dividing the initial image into the plurality of sub-region images, and obtaining the feature vector corresponding to each sub-region image of the plurality of sub-region images by performing the feature extraction on each sub-region image comprises:
equally dividing the initial image into the plurality of sub-region images according to a length and a width of the initial image;
extracting features from each sub-region image using a preset feature extraction method, and obtaining a plurality of feature vectors by converting the features extracted from each sub-region image into one feature vector; and
calibrating a position for each of the plurality of feature vectors so that each feature vector comprises position information of the corresponding sub-region image in the initial image.

7. The depth estimation method according to claim 6, wherein the obtaining the depth image corresponding to the initial image using decoders of the depth estimation model based on the depth information corresponding to each feature vector comprises:
generating the depth image based on the depth information corresponding to each feature vector and the corresponding position that is calibrated.

8. An electronic device, comprising:
at least one processor; and
a storage device storing a computer program, which when executed by the at least one processor, cause the at least one processor to:
divide an initial image into a plurality of sub-region images, and obtain a feature vector corresponding to each sub-region image of the plurality of sub-region images by performing a feature extraction on each sub-region image;
input the feature vector corresponding to each sub-region image into a depth estimation model, and obtain depth information corresponding to each feature vector using encoders of the depth estimation model; and
obtain a depth image corresponding to the initial image using decoders of the depth estimation model based on the depth information corresponding to each feature vector.

9. The electronic device according to claim 8, wherein the depth estimation model comprises a Transformer model, the Transformer model comprises the encoders and the decoders, and each of the encoders comprises a linear self-attention mechanism and a multilayer perceptron.

10. The electronic device according to claim 9, wherein a t-th encoder of the decoders outputs Xₜ using a formula:
$${X}_{t} = Transformer ( {X}_{t - 1} ) = M A ( {X}_{t - 1} ) + M L P ( M A ( {X}_{t - 1} ) ) ,$$
wherein, “t” represents an integer greater than 1, “Xₜ₋₁” represents an output of the (t−1)-th encoder, “MA” represents the linear self-attention mechanism, and “MLP” represents the multilayer perceptron.

11. The electronic device according to claim 10, wherein the linear self-attention mechanism associates inputs using a formula:
$$MA ( X ) = contact ( {A}_{1} ( X ) , {A}_{2} ( X ) , … , {A}_{m} ( X ) , … , {A}_{n} ( X ) ) {W}_{M A} ,$$
wherein,
$${A}_{m} ( X ) = X + softmax ( \frac{X {W}_{m Q} {E}_{m} X {W}_{m K}}{\sqrt{{d}_{l}}} ) {F}_{m} X {W}_{m V} ,$$
“Aₘ” represents a m-th attention head in n-head self-attention, “X” represents an input of the linear self-attention mechanism, “softmax” represents a softmax function, “conact” represents a conact function, “W_{MA}”, “W_{mQ}”, “W_{mK}”, “W_{mV}”, “Eₘ” and “Fₘ” represent matrices that have been pre-trained, “dₗ” represents a number of columns of a vector “K”, where K=XW_{mK}.

12. The electronic device according to claim 11, wherein the multilayer perceptron obtains an output using a formula:
$$M L P ( X ) = X {\prod }_{r = 1}^{R} {W}_{r} ,$$
wherein “X” represents an input of the multilayer perceptron, “r” represents a r-th hidden layer of the multilayer perceptron, “R” represents a number of hidden layers of the multilayer perceptron, and “Wᵣ” represents a weight matrix of the r-th hidden layer.

13. The electronic device according to claim 8, wherein the at least one processor divides the initial image into the plurality of sub-region images, and obtains the feature vector corresponding to each sub-region image of the plurality of sub-region images by performing the feature extraction on each sub-region image by:
equally dividing the initial image into the plurality of sub-region images according to a length and a width of the initial image;
extracting features from each sub-region image using a preset feature extraction method, and obtaining a plurality of feature vectors by converting the features extracted from each sub-region image into one feature vector; and
calibrating a position for each of the plurality of feature vectors so that each feature vector comprises position information of the corresponding sub-region image in the initial image.

14. The electronic device according to claim 13, wherein the at least one obtains the depth image corresponding to the initial image using decoders of the depth estimation model based on the depth information corresponding to each feature vector by:
generating the depth image based on the depth information corresponding to each feature vector and the corresponding position that is calibrated.

15. A non-transitory storage medium having a computer program stored thereon, which when executed by a processor, a depth estimation method is implemented, wherein the depth estimation method comprises:
dividing an initial image into a plurality of sub-region images, and obtaining a feature vector corresponding to each sub-region image of the plurality of sub-region images by performing a feature extraction on each sub-region image;
inputting the feature vector corresponding to each sub-region image into a depth estimation model, and obtaining depth information corresponding to each feature vector using encoders of the depth estimation model; and
obtaining a depth image corresponding to the initial image using decoders of the depth estimation model based on the depth information corresponding to each feature vector.

16. The non-transitory storage medium according to claim 15, wherein the depth estimation model comprises a Transformer model, the Transformer model comprises the encoders and the decoders, and each of the encoders comprises a linear self-attention mechanism and a multilayer perceptron.

17. The non-transitory storage medium according to claim 16, wherein a t-th encoder of the decoders outputs Xₜ using a formula:
$${X}_{t} = Transformer ( {X}_{t - 1} ) = M A ( {X}_{t - 1} ) + M L P ( M A ( {X}_{t - 1} ) ) ,$$
wherein, “t” represents an integer greater than 1, “Xₜ₋₁” represents an output of the (t−1)-th encoder, “MA” represents the linear self-attention mechanism, and “MLP” represents the multilayer perceptron.

18. The non-transitory storage medium according to claim 17, wherein the linear self-attention mechanism associates inputs using a formula:
$$MA ( X ) = contact ( {A}_{1} ( X ) , {A}_{2} ( X ) , … , {A}_{m} ( X ) , … , {A}_{n} ( X ) ) {W}_{M A} ,$$
wherein,
$${A}_{m} ( X ) = X + softmax ( \frac{X {W}_{m Q} {E}_{m} X {W}_{m K}}{\sqrt{{d}_{l}}} ) {F}_{m} X {W}_{m V} ,$$
“Aₘ” represents a m-th attention head in n-head self-attention, “X” represents an input of the linear self-attention mechanism, “softmax” represents a softmax function, “conact” represents a contact function, “W_{MA}”, “W_{mQ}”, “W_{mK}”, “W_{mV}”, “Eₘ” and “Fₘ” represent matrices that have been pre-trained, “dₗ” represents a number of columns of a vector “K”, where K=XW_{mK}.

19. The non-transitory storage medium according to claim 18, wherein the multilayer perceptron obtains an output using a formula:
$$MLP ( X ) = X {\prod }_{r = 1}^{R} {W}_{r} ,$$
wherein “X” represents an input of the multilayer perceptron, “r” represents a r-th hidden layer of the multilayer perceptron, “R” represents a number of hidden layers of the multilayer perceptron, and “Wᵣ” represents a weight matrix of the r-th hidden layer.

20. The non-transitory storage medium according to claim 15, wherein the dividing the initial image into the plurality of sub-region images, and obtaining the feature vector corresponding to each sub-region image of the plurality of sub-region images by performing the feature extraction on each sub-region image comprises:
equally dividing the initial image into the plurality of sub-region images according to a length and a width of the initial image;
extracting features from each sub-region image using a preset feature extraction method, and obtaining a plurality of feature vectors by converting the features extracted from each sub-region image into one feature vector; and
calibrating a position for each of the plurality of feature vectors so that each feature vector comprises position information of the corresponding sub-region image in the initial image.
